(19) United States
(12) Patent Application Publication
(10) Pub. No.: US 2006/0090034 A1
(43) Pub. Date: Apr. 27, 2006

(54) System and method for providing a way memoization in a processing environment

(75) Inventors: Toru Ishihara, Sunnyvale, CA (US); Farzan Fallah, San Jose, CA (US)

Correspondence Address: BAKER BOTTS L.L.P., 2001 ROSS AVENUE, SUITE 600, DALLAS, TX, 75201-2980, US

(73) Assignee: Fujitsu Limited

(21) Appl. No.: 10/970,882

(22) Filed: Oct. 22, 2004

(51) Int. Cl. G06F 12/00; G06F 12/10

(52) U.S. Cl. 711/118; 713/320; 711/202

(57) ABSTRACT

An apparatus is provided that a way memoization, which may utilize a memory address buffer element that is operable to store information associated with previously accessed addresses. The memory address buffer element may be accessed in order to reduce power consumption in accessing a cache memory. A plurality of entries associated with a plurality of data segments may be stored in the memory address buffer element. For a selected one or more of the entries there is an address field that points to a way that includes a requested data segment. The memory address buffer element includes one or more ways that are operable to store one or more of the data segments that may be retrieved from the cache memory. One or more of the previously accessed addresses may be replaced with one or more tags and one or more set indices that correlate to the previously accessed addresses.

### TECHNICAL FIELD OF THE INVENTION

The present invention relates generally to circuit design and, more particularly, to a system and method for providing a way memoization in a processing environment.

### BACKGROUND OF THE INVENTION

The proliferation of integrated circuits has placed increasing demands on the design of digital systems included in many devices, components, and architectures. The number of digital systems that include integrated circuits continues to steadily increase: such augmentations being driven by a wide array of products and systems. Added functionalities may be implemented in integrated circuits in order to execute additional tasks or to effectuate more sophisticated operations (potentially more quickly) in their respective applications or environments.

Computer processors that are associated with integrated circuits generally have a number of cache memories that dissipate a significant amount of energy. There are generally two types of cache memories: instruction-caches (I-caches) and data-caches (D-caches). Many cache memories may interface with other components through instruction address and data address buses or a multiplexed bus, which can be used for both data and instruction addresses. The amount of energy dissipated from the cache memories can be significant when compared to the total chip power consumption. These deficiencies provide a significant challenge to system designers and component manufacturers who are relegated the task of alleviating such power consumption problems.

### SUMMARY OF THE INVENTION

In accordance with the present invention, techniques for reducing energy consumption on associated cache memories are provided. According to particular embodiments, these techniques can reduce power consumption of electronic devices by reducing comparisons performed when accessing cache memories.

According to a particular embodiment, an apparatus for reducing power on a cache memory is provided that includes a memory address buffer element coupled to the cache memory. A way memoization may be implemented for the cache memory, the way memoization utilizing the memory address buffer element that is operable to store information associated with previously accessed addresses. The memory address buffer element may be accessed in order to reduce power consumption in accessing the cache memory. A plurality of entries associated with a plurality of data segments may be stored in the memory address buffer element, and for a selected one or more of the entries there is an address field that points to a way that includes a requested data segment. One or more of the previously accessed addresses may be replaced with one or more tags and one or more set indices that correlate to one or more of the previously accessed addresses.

Embodiments of the invention may provide various technical advantages. Certain embodiments provide for a significant reduction in comparison activity associated with a given cache memory. Certain ways may also be deactivated or disabled because the appropriate way is referenced by a memory address buffer, which stores critical information associated with previously accessed data. Minimal comparison and way activity generally yields a reduction in power consumption and an alleviation of wear on the cache memory system. Thus, such an approach generally reduces cache memory activity. In addition, such an approach does not require a modification of the cache architecture. This is an important advantage because it makes it possible to use the processor core with previously designed caches or processor systems provided by diverse vendor groups.

Other technical advantages of the present invention will be readily apparent to one skilled in the art. Moreover, while specific advantages have been enumerated above, various embodiments of the invention may have none, some, or all of these advantages.

### BRIEF DESCRIPTION OF THE DRAWINGS

For a more complete understanding of the present invention and its advantages, reference is now made to the following descriptions, taken in conjunction with the accompanying drawings, in which:

FIG. 1 is a simplified block diagram illustrating a system for providing a memoization technique for communications in a processor according to various embodiments of the present invention;

FIG. 2 is a simplified schematic diagram illustrating various example way structures and a memory address buffer associated with the system of FIG. 1; and

FIG. 3 is a simplified block diagram of an example construction of several circuits, which may be included in the system of FIG. 1.

### DETAILED DESCRIPTION OF THE DRAWINGS

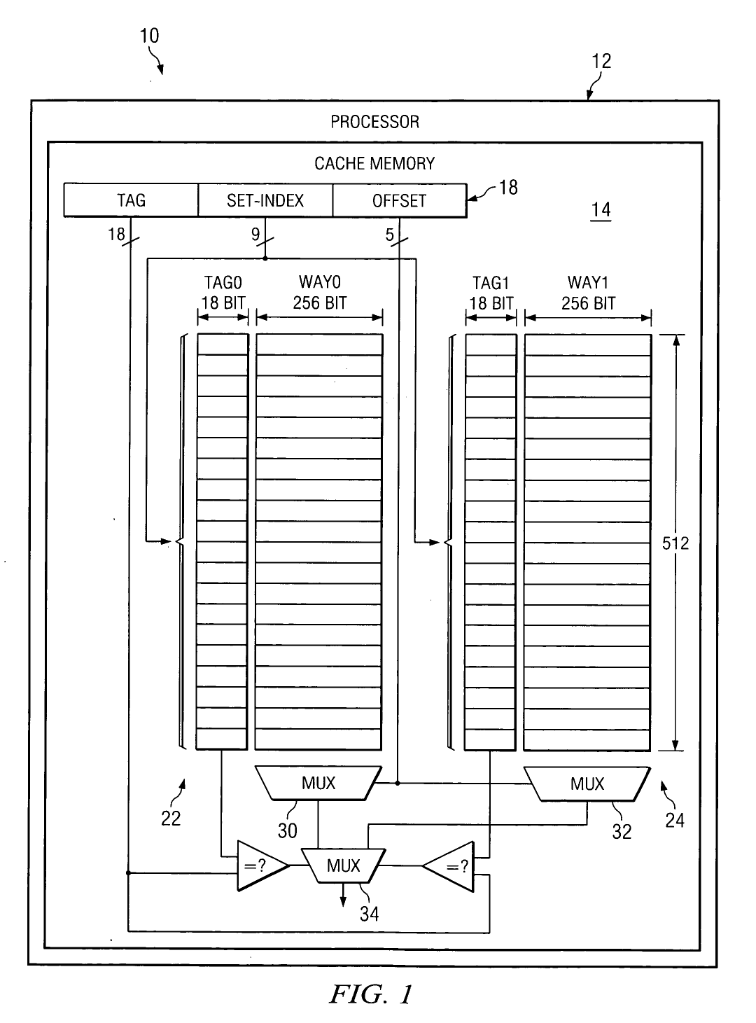

FIG. 1 is a simplified block diagram illustrating a processing system 10 for providing a memoization technique for communications in a processor 12 according to various embodiments of the present invention. Processor 12 may include a main memory (not shown) and a cache memory 14, which may be coupled to each other using an address bus and a data bus. Cache memory 14 may include a memory address 18, which includes a tag, a set-index, and an offset. Cache memory 14 may also include a way0 22, a way1 24, and multiplexers 30, 32, and 34. Way0 may include a tag0 and way1 may include a tag1, whereby each way may suitably interface with their corresponding tag structure. The illustration of FIG. 1 represents a two-way associative cache memory in one example embodiment: permutations and alternatives to such an arrangement may readily be accommodated by system 10. Note that FIG. 1 also includes a number of bit configurations and sizes, which have been provided as examples only of some of the possible arrangements associated with cache memory 14. Such delegations are arbitrary and, accordingly, should be construed as such.

System 10 operates to implement a technique for eliminating redundant cache-tag and cache-way accesses to reduce power consumption. System 10 can maintain a small number of most recently used (MRU) addresses in a memory address buffer (MAB) and omit redundant tag and way accesses when there is a MAB-hit. Since the approach keeps only tag and set-index values in the MAB, the energy and area overheads are relatively small: even for a MAB with a large number of entries. Furthermore, the approach does not sacrifice the performance: neither the cycle time nor the number of executed cycles increases during operation. Hence, instead of storing address values, tag values and set-index values are stored in the MAB. The number of tag entries and that of set-index entries may be different. This helps to reduce the area of the MAB without sacrificing the hit rate of the MAB. Furthermore, it makes zero-delay overhead possible because the MAB-access can be done in parallel with address calculation.

Processor 12 may be included in any appropriate arrangement and, further, include algorithms embodied in any suitable form (e.g. software, hardware, etc.). For example, processor 12 may be a microprocessor and be part of a simple integrated chip, an application specific integrated circuit (ASIC), a field programmable gate array (FPGA), or any other suitable processing object, device, or component. The address bus and the data bus are wires capable of carrying data (e.g. binary data). Alternatively, such wires may be replaced with any other suitable technology (e.g. optical radiation, laser technology, etc.) operable to facilitate the propagation of data.

Cache memory 14 is a storage element operable to maintain information that may be accessed by processor 12. Cache memory 14 may be a random access memory (RAM), a read only memory (ROM), an erasable programmable ROM (EPROM), an electrically erasable programmable ROM (EEPROM), a fast cycle RAM (FCRAM), a static RAM (SRAM), or any other suitable object that is operable to facilitate such storage operations. In other embodiments, cache memory 14 may be replaced by another processor or software that is operable to interface with processor 12 in a similar fashion to that outlined herein.

Note that for purposes of teaching and discussion, it is useful to provide some background overview as to the way in which the tendered invention operates. The following foundational information describes one problem that may be solved by the present invention. This background information may be viewed as a basis from which the present invention may be properly explained. Such information is offered earnestly for purposes of explanation only and, accordingly, should not be construed in any way to limit the broad scope of the present invention and its potential applications.

On-chip cache memories are one of the most power hungry components of processors (esp. microprocessors). There are generally two types of cache memories: instruction-caches (I-caches) and data-caches (D-caches). In a given cache memory, there are several “ways.” Based on the address of the data, the data may be stored in any of several locations in the cache memory corresponding to a given address. For example, if there are two ways, the data may be provided in either way. FIG. 1 represents an architecture that includes two ways 22 and 24. The memory address may be used as an index for the rows. Based on the memory address, a given row may be selected. Thus, the data may be included in a given row in a given way.

There is generally a tag for each way and for each data segment stored in cache memory 14. The tag of the memory address may be compared to the tag of way0 and way1. If a match exists, this reflects the condition that the data segment resides in cache memory 14. If no match exists, then a cache miss exists such that the main memory (not illustrated) should be referenced in order to retrieve the data.

Each time cache memory 14 is accessed, energy is expended and power is consumed. Thus, the comparison outlined above is taxing on the processing system. If this access process can be minimized, then energy consumption may be reduced. Note that in practical terms, if a given location in cache memory 14 is accessed, then it will be subsequently accessed in the future. Hence, by keeping track of the memory accesses, a powerful tool may be developed to record previously accessed accesses addresses. A table (i.e. a MAB) may be used to store such information.

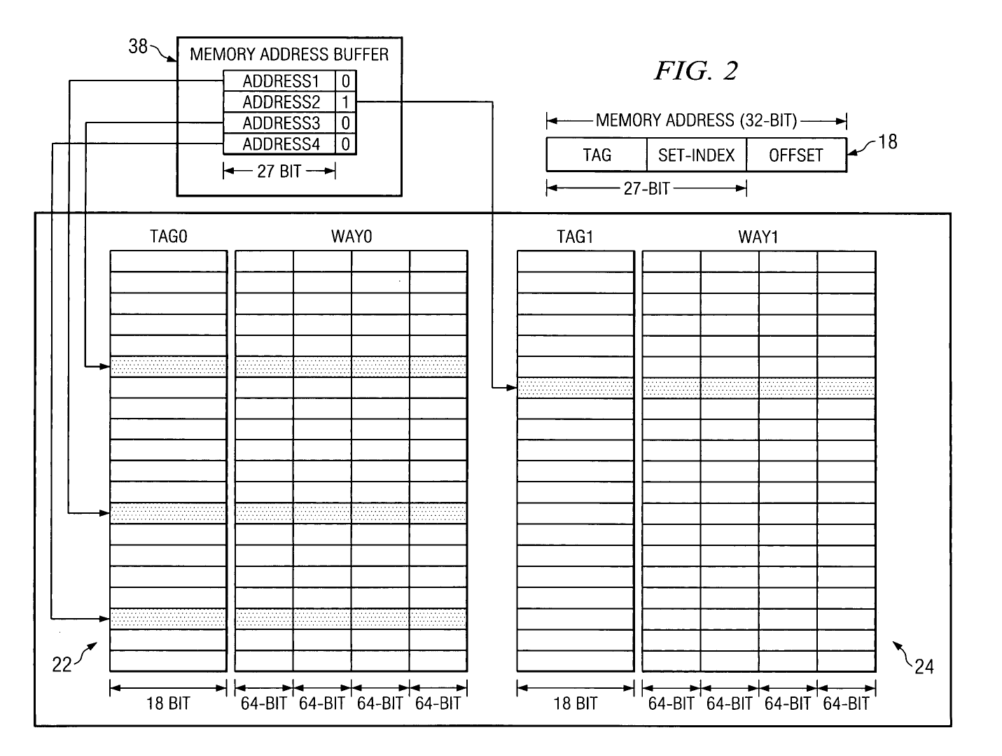

FIG. 2 is a simplified schematic diagram illustrating various example ways and a memory address buffer associated with system 10 of FIG. 1. FIG. 2 represents a situation in which a small number of most recently used (MRU) addresses and a target cache-way number are stored in a MAB 38. If a MAB hit is present, irrelevant cache-tag memories and unnecessary cache-ways are disabled.

Consider an example associated with FIG. 2 that is illustrative. If address 2, which is stored in way1, is accessed that information may be recorded in MAB 38. MAB 38 represents a storage table that maintains such information. Accessed addresses (inclusive of their corresponding way and/or row) may be stored in this fashion. In a subsequent task, consider a case where address 2 is sought to be accessed again. Accordingly, MAB 38 is referenced, where it is determined that this address was accessed previously. Hence, a cache hit is present for this address. Additionally, it may be ascertained that this data segment is included in way1 24. In performing this referencing function, the tag comparison is avoided. Further, such an approach allows sense amplifiers of way0 22 to be turned off. Thus, by recognizing the way that includes the desired data segment, other ways may be disabled. This saves power in making tag comparisons and in turning on all ways in order to identify the location of the data segment. Data within MAB 38 may be suitably updated at any appropriate time. If one address is replaced by another address in cache memory 14, MAB 38 must be updated to reflect this condition.

MAB 38 may be provided with software in one embodiment that achieves the functions as detailed herein. Alternatively, the augmentation or enhancement may be provided in any suitable hardware, component, device, ASIC, FPGA, ROM element, RAM element, EPROM, EEPROM, algorithm, element or object that is operable to perform such operations. Note that such a (MAB) functionality may be provided within processor 12 or provided external to processor 12, allowing appropriate storage to be achieved by MAB 38 in any appropriate location of system 10.

Note that unlike a MAB that is used for a D-cache, the inputs of MAB 38 used for an instruction cache can be one of the following three types: 1) an address stored in a link register, 2) a base address (i.e., the current program counter address) and a displacement value (i.e., a branch offset), and 3) the current program counter address and its stride. In the case of an inter-cache-line sequential flow, the current program counter address and the stride of the program counter can be chosen as inputs for MAB 38. The stride can be treated as the displacement value. If the current operation is a “branch (or jump) to the link target”, the address in the link register can be selected as the input of MAB 38. Otherwise, the base address and the displacement can be used for the data cache.

Note that since MAB 38 is accessed in parallel with the adder used for address generation, there is generally no delay overhead. Furthermore, this approach does not require modifying the cache architecture. This is an important advantage because it makes it possible to use the processor core with previously designed caches or other processors provided by different vendors. Hence, system 10 achieves a significant reduction in comparison activity associated with cache memory 14. Certain ways can be deactivated or disabled because the appropriate way is referenced by the memory address buffer. Minimal comparison and way activity generally yields a reduction in power consumption and an alleviation of wear on cache memory 14. Thus, such an approach generally reduces cache memory activity, augments system performance, and can even be used to accommodate increased bandwidth.

Note that MAB 38 has two types of entries: 1) tag (18 bits) and cflag (2 bits); and 2) set-index (9 bits). The 2-bit cflag can be used to store the carry bit of the 14-bit adder and the sign of the displacement value. If the number of entries for tags is n₁ and the number of entries for set-indices is n₂, MAB 38 can store the information about n₁×n₂ addresses. For example, a 2×8-entry MAB can store information about 16 addresses. For each address, there can be a flag indicating whether the information is valid. The flag corresponding to the tag entry i and set-index entry j can be denoted by vflag[i][j]. The MAB entries can be updated using any appropriate protocol, e.g. using a least recently used (LRU) policy.

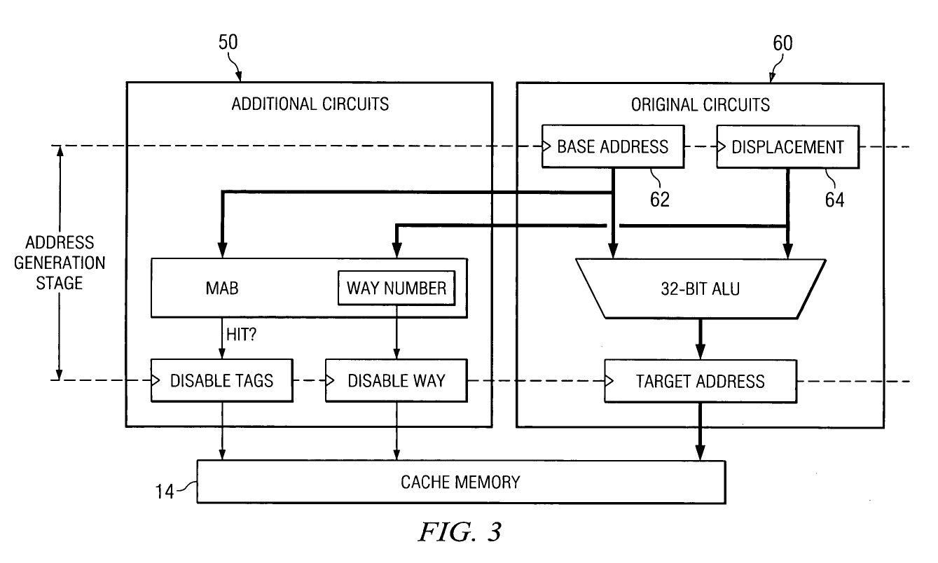

FIG. 3 is a simplified block diagram of an example construction of several circuits 50 and 60, which may be included in system 10 of FIG. 1. Note that, as detailed herein, cache memory 14 may add a displacement element (i.e. a displacement address or a displacement value) to the base address. These two objects reflect two fields of instruction, whereby such elements are reflected by items 62 and 64. Together, these two elements provide a target address. Hence, two numbers may be added in order to generate this target address. MAB 38 may account for tag and set index parameters to address this scenario. These can be used to detect a MAB hit.

Consider the 2-way set associative cache described in FIG. 1 in conjunction with the details of FIG. 2. If address 1 is cached in tag0, the way-number bit in the MAB entry corresponding to address 1 will be 0. Similarly, the way numbers corresponding to address2, address3, and address4 will be 1, 0, and 0, respectively. When there is a MAB-hit, only a single way specified by the way-number bit is activated and the other ways and their corresponding tag memories stay inactive. This technique can reduce the number of redundant tag accesses by 70%-90%. Unfortunately, the unit generating memory addresses is on the critical path in most processors. Therefore, accessing MAB 38 after generating the memory address increases the cycle time.

This technique is based on the observation that the target address is the sum of a base address and a displacement, which usually takes a small number of values. Furthermore, the values are typically small. Therefore, the hit rate of MAB 38 can be improved by keeping only a small number of the most recently used tags. For example, assume the bit width of tag memory, the number of sets in the cache, and the size of cache lines are 18, 512, and 32 bytes, respectively. The width of the set-index and offset fields will be 9 and 5 bits, respectively. Since most displacement values are less than 214, tag values can be easily calculated without address generation. This can be done by checking the upper 18 bits of the base address, the sign-extension of the displacement, and the carry bit of a 14-bit adder, which adds the low 14 bits of the base address and the displacement. Therefore, the delay of the added circuit is the sum of the delay of the 14-bit adder and the delay of accessing the set-index table.

This delay is generally smaller than the delay of the 32-bit adder used to calculate the address. Hence, such a technique (as outlined herein) does not experience any delay penalty. Note that if the displacement value is more than or equal to 2¹⁴ or less than −2¹⁴, there will be a MAB miss, but the chance of this happening is generally less than 1%.

Consider another example, wherein an address corresponding to a tag value x and a set-index value y is present. Depending on whether there is a hit or a miss for x and y, there are four different possibilities. Possibility one: there are hits for both x and y. In this case the address corresponding to (x, y) is in the table. Assuming i and j denote the entry numbers for x and y, respectively, vflag[i][j] is set to 1. Possibility two: there is a miss for x and a hit for y. If j denotes the entry number for y and x replaces entry i in MAB 38, vflag[i][j] has to be set to 1, while other vflags[i][*] are set to 0. Possibility three: there is a hit for x and a miss for y. Assuming i denotes the entry number of x, and y replaces entry j in MAB 38, vflag[i] [j] is set to 1, while other vflags[*][j] are set to 0. Possibility four: finally, there are misses for both j and y. If x and y replace entry i and entry j in MAB 38, vflag[i][j] will be set to 1 and other vflags[i][*] and vflag[*][j] will be set to 0.

To keep MAB 38 consistent with cache memory 14, if not all upper 18 bits of the displacement are zero and not all of them are one, vflags corresponding to the entry LRU are set to 0. As long as the number of tag entries in MAB 38 is smaller than the number of cache-ways, this guarantees the consistency between MAB 38 and the cache. In other words, if a tag and set-index pair residing in MAB 38 is valid, data corresponding to them will always reside in cache memory 14. The critical path delay is the sum of the delay of the 14-bit adder and the delay of the 9-bit comparator, which is smaller than the clock period of the target processor.

Note that the scenario of FIG. 3 reflects a situation in which no change in pipeline structure or cache architecture is required. Such an architecture is readily available as a synthesizable core (RTL code) and is easy to integrate (suited to soft-IP based design). Moreover, such an arrangement does not yield a performance penalty. The MAB lookup is done in parallel with the address generation, whereby the delay of MAB 38 is smaller than that of a 32-bit ALU. There is not an extra cycle that is required in case of a MAB-miss.

The preceding description focuses on the operation of MAB 38. However, as noted, system 10 contemplates using any suitable combination and arrangement of functional elements for providing the storage operations, and these techniques can be combined with other techniques as appropriate. Some of the steps illustrated in FIG. 3 may be changed or deleted where appropriate and additional steps may also be added to the flow. These changes may be based on specific communication system architectures or particular arrangements or configurations and do not depart from the scope or the teachings of the present invention. It is also critical to note that the preceding description details a number of techniques for reducing power on cache memory 14. While these techniques have been described in particular arrangements and combinations, system 10 contemplates cache memory 14 using any appropriate combination and ordering of these operations to provide for decreased power consumption.

Although the present invention has been described in detail with reference to particular embodiments illustrated in FIGS. 1 through 3, it should be understood that various other changes, substitutions, and alterations may be made hereto without departing from the spirit and scope of the present invention. For example, although the present invention has been described with reference to a number of elements included within system 10, these elements may be rearranged or positioned in order to accommodate any suitable processing and communication architectures. In addition, any of the described elements may be provided as separate external components to system 10 or to each other where appropriate. The present invention contemplates great flexibility in the arrangement of these elements, as well as their internal components. Such architectures may be designed based on particular processing needs where appropriate.

Numerous other changes, substitutions, variations, alterations, and modifications may be ascertained to one skilled in the art and it is intended that the present invention encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this invention in any way that is not otherwise reflected in the appended claims.

What is claimed is:

1. A method for reducing power of a cache memory, comprising:
implementing a way memoization for a cache memory, the way memoization utilizing a memory address buffer element operable to store information associated with previously accessed addresses, wherein the memory address buffer element may be accessed in order to reduce power consumption in accessing the cache memory;
storing a plurality of entries associated with a plurality of data segments, wherein for a selected one or more of the entries there is an address field that points to a way that includes a requested data segment; and
replacing one or more of the previously accessed addresses with one or more tags and one or more set indices that correlate to one or more of the previously accessed addresses.

2. The method of claim 1, further comprising:
referencing the memory address buffer element in order to determine if the requested data segment currently resides in the cache memory.

3. The method of claim 1, further comprising:
determining whether or not a memory address buffer element hit is present, the hit reflecting a condition where the requested data segment is present in the cache memory; and
disabling one or more of the ways once a selected one of the ways has been identified as including the requested data segment.

4. The method of claim 1, further comprising:
updating memory address buffer element by replacing one or more of the previously accessed addresses included in the cache memory with one or more additional addresses.

5. The method of claim 1, further comprising:
generating a target address associated with the requested data segment by using a base address and a displacement element, whereby the target address may be communicated to the memory address buffer element in order to retrieve the requested data segment.

6. The method of claim 1, further comprising:
implementing the cache memory on a processor that is operable to perform one or more electronic tasks and to request one or more of the data segments from the cache memory.

7. A system for reducing power on a cache memory, comprising:
means for implementing a way memoization for a cache memory;
means for utilizing a memory address buffer element operable to store information associated with previously accessed addresses, wherein the memory address buffer element may be accessed in order to reduce power consumption in accessing the cache memory;
means for storing a plurality of entries associated with a plurality of data segments, wherein for a selected one or more of the entries there is an address field that points to a way that includes a requested data segment; and
means for replacing one or more of the previously accessed addresses with one or more tags and one or more set indices that correlate to one or more of the previously accessed addresses.

8. The system of claim 7, further comprising:
means for referencing the memory address buffer element in order to determine if the requested data segment currently resides in the cache memory.

9. The system of claim 7, further comprising:
means for determining whether or not a memory address buffer element hit is present, the hit reflecting a condition where the requested data segment is present in the cache memory; and
means for disabling one or more of the ways once a selected one of the ways has been identified as including the requested data segment.

10. The system of claim 7, further comprising:
means for updating the memory address buffer element by replacing one or more of the previously accessed addresses included in the cache memory with one or more additional addresses.

11. The system of claim 7, further comprising:
means for generating a target address associated with the requested data segment by using a base address and a displacement element, whereby the target address may be communicated to the cache memory address buffer element in order to retrieve the requested data segment.

12. Software for reducing power on a cache memory, the software being embodied in a computer readable medium and comprising computer code such that when executed is operable to:
implement a way memoization for a cache memory;
utilize a memory address buffer element operable to store information associated with previously accessed addresses, wherein the memory address buffer element may be accessed in order to reduce power consumption in accessing the cache memory;
store a plurality of entries associated with a plurality of data segments, wherein for a selected one or more of the entries there is an address field that points to a way that includes a requested data segment; and
replace one or more of the previously accessed addresses with one or more tags and one or more set indices that correlate to one or more of the previously accessed addresses.

13. The medium of claim 12, wherein the code is further operable to:
reference the memory address buffer element in order to determine if the requested data segment currently resides in the cache memory.

14. The medium of claim 12, wherein the code is further operable to:
determine whether or not a memory address buffer element hit is present, the hit reflecting a condition where the requested data segment is present in the cache memory; and
disable one or more of the ways once a selected one of the ways has been identified as including the requested data segment.

15. The medium of claim 12, wherein the code is further operable to:
update the cache memory by replacing one or more of the previously accessed addresses included in the memory address buffer element with one or more additional addresses.

16. The medium of claim 12, further wherein the code is further operable to:
generate a target address associated with the requested data segment by using a base address and a displacement element, whereby the target address may be communicated to the memory address buffer element in order to retrieve the requested data segment.

17. An apparatus for reducing power on a cache memory, comprising:
a cache memory; and
a memory address buffer element coupled to the cache memory, wherein a way memoization may be implemented for the cache memory, the way memoization utilizing the memory address buffer element that is operable to store information associated with previously accessed addresses, and wherein the memory address buffer element may be accessed in order to reduce power consumption in accessing the cache memory, a plurality of entries associated with a plurality of data segments may be stored in the memory address buffer element, and for a selected one or more of the entries there is an address field that points to a way that includes a requested data segment, one or more of the previously accessed addresses may be replaced with one or more tags and one or more set indices that correlate to one or more of the previously accessed addresses.

18. The apparatus of claim 17, wherein the memory address buffer element may be accessed in order to determine if the requested data segment currently resides in the cache memory.

19. The apparatus of claim 17, wherein it may be determined whether or not a memory address buffer element hit is present, the hit reflecting a condition where the requested data segment is present in the cache memory, and wherein one or more of the ways may be disabled once a selected one of the ways has been identified as including the requested data segment.

20. The apparatus of claim 17, wherein the cache memory may be updated by replacing one or more of the previously accessed addresses included in the cache memory with one or more additional addresses.

21. The apparatus of claim 17, wherein a target address associated with the requested data segment may be generated by using a base address and a displacement element, whereby the target address may be communicated to the cache memory in order to retrieve the requested data segment.

22. The apparatus of claim 17, further comprising:
a processor, which is operable to interface with the cache memory, to perform one or more electronic tasks, and to request one or more of the data segments from the cache memory.

23. The apparatus of claim 17, wherein a number of the entries and a number of the set indices is different.

24. The apparatus of claim 17, wherein access to the memory address buffer element is executed in parallel with an address calculation.

25. The apparatus of claim 17, wherein one or more flags are provided that correspond to one or more of the previously accessed addresses and that identify whether one or more of the data segments are valid.
